(19) United States
(12) Patent Application Publication
(10) Pub. No.: US 2017/0252984 A1
(43) Pub. Date: Sep. 7, 2017

(54) Wind Turbine Blade with Customised Chord Length

(71) Applicant: Envision Energy (Denmark) ApS, Silkeborg (DK)

(72) Inventor: Wout Ruijter, Silkeborg (DK)

(21) Appl. No.: 15/511,266

(22) PCT Filed: Jul. 14, 2015
(86) PCT No.: PCT/DK2015/050220

§ 371 Date: Mar. 15, 2017

(30) Foreign Application Priority Data
Sep. 15, 2014 (DK) PA 2014 70569

(51) Int. Cl. B29C 70/34; F03D 1/06; B29C 33/30

(52) U.S. Cl. CPC B29C 70/345; B29C 33/306; F03D 1/0675; B29L 2031/085

(57) ABSTRACT

The present invention relates to a wind turbine blade mould comprising a first mould part and a second mould part, where said first mould surface is configured for moulding a pressure side shell of a wind turbine blade, where said second mould surface is configured for moulding a suction side shell of a wind turbine blade, and where the wind turbine blade mould and thus also a wind turbine blade moulded in said mould comprise a first end, a second end, a pressure side shell, a suction side shell, and further comprise a leading edge area and a trailing edge area. The present invention also relates to a wind turbine blade and a manufacturing method for producing a wind turbine blade using a wind turbine mould as mentioned above.

### FIELD OF THE INVENTION

The present invention relates to a wind turbine blade mould comprising a first mould part having a first mould surface and a second mould part having a second mould surface, a first end and a second end, where said first mould surface is configured for moulding a pressure side shell of a wind turbine blade, where said second mould surface is configured for moulding a suction side shell of a wind turbine blade, where said first end is configured for moulding a first end e.g. a tip end of a wind turbine blade, and where the second end is configured for moulding a second end e.g. a root end of a wind turbine blade, where the first end is located in the opposite end of the second end, and where the wind turbine blade mould and thus also a wind turbine blade moulded in said mould comprise a first end, a second end, a pressure side shell, a suction side shell, and further comprise a leading edge area and a trailing edge area.

The present invention also relates to a wind turbine blade and a manufacturing method for producing a wind turbine blade using a wind turbine mould as mentioned above.

### BACKGROUND OF THE INVENTION

The development of more cost-effective wind turbines means that the size and height of wind turbines today have increased. The size of wind turbine blades today has also increased which in turn also increases the production costs as it becomes more and more difficult to design an efficient blade. Hence, there is a need for improving the aerodynamic shape and structural strength of wind turbine blades, as well as optimising the production of such blades.

Wind turbine blades typically comprise one or two fibre reinforced shell parts which are supported by using internal reinforcement structures. One way of manufacturing a wind turbine blade is to mould two separate shell parts in separate moulds. During layup of fibre material in the mould, load carrying members, such as spar caps and other structural means, are integrated into the layup for the shell parts either as premade parts, but also parts formed during the shell layup process are an alternative.

When combining the two shell parts in a gluing process, shear webs are added in between the shell parts and glued and cured in the same step. An alternative way of production is to lay up all the fibre material for the complete wind turbine blade in a first mould part and subsequently arrange a second mould part in relation to the first and then to impregnate the fibre material in a single process. This will of course save the gluing process.

The shape and internal structure of a wind turbine blade is generally designed so that the resulting turbine has a low cost of energy in a particular target market (wind range and environmental requirements), which makes the design a trade-off between power production, structural mass and costs, induced loads, noise and transport considerations. As a consequence the efficiency of the blades is very often also a trade-off as it is costly to manufacture and not least time-consuming to design and manufacture moulds for each and every specific blade condition. Thus, blades are designed, moulds are prepared and blades are manufactured in order to be as close to optimum as possible.

To obtain a closer to optimum solution it is known to attach different devices such as vortex generators, gurney flaps, trailing edge extender in the form of a tape to the wind turbine blade, in order to make the trade-offs less problematic and thus make a specific blade design perform better under specific conditions.

Vortex generators as well as gurney flaps are used to optimise the aerodynamic performance, and a trailing edge extender from tape will reduce noise generated from the blade. Such tape is so flexible that it has no capacity to redirect the air flow passing over the blade, and hence it has no impact on the lift coefficient of the blade profile.

Until now it has been common to manufacture longer blades in order to optimise the production of wind turbines situated in less attractive positions e.g. in the middle of a wind turbine park, where the wind conditions per definition are influenced by the wind turbines closer to the front lines of the wind turbine park. Using longer blades do however call for longer moulds, which are expensive.

None of the prior art moulds for wind turbine blades and none of the prior art wind turbine blades are designed for customisation of the core blade. Only adding of aero-dynamic devices as mentioned has been known. There is thus a need for wind turbine blades that can be more or less customised for a specific use, for a specific position in a wind turbine park or for other specific conditions, where the wind turbine blade is manufactured in a “standard mould”. By the terms “standard mould” and “multi-mould” are meant that such a mould allows for production of blades having a specific design, but with possibility for customising e.g. the length of the trailing edge in the chord direction, while the main part of the blade cross-section is unchanged.

DE 102012223810 A1 discloses a mould for manufacturing wind turbine blades, comprising a set of inlays for placement at the tip end of the mould surface, wherein each inlay has a tip end profile that defines a longitudinal length of the wind turbine blade. This solution only allows the manufacturing of wind turbine blades with different longitudinal lengths.

WO 2012/093136 A2 discloses a modular based mould for manufacturing wind turbine blades, comprising a first set of mould sections having different profiles for the blade root area, a second set of mould sections having different profiles for the tip end area, and optionally a third set of mould sections having different profiles for the aerodynamic body of the wind turbine. This solution adds to the complexity and cost of manufacturing wind turbine blades as the mould has to be disassembled and reassembled every time that the profile or length of the wind turbine blade is changed.

### OBJECT OF THE INVENTION

An object of this invention is to provide a mould for a wind turbine blade as well as a wind turbine blade, where said wind turbine blade has an aerodynamic design, where the trailing edge of said blade can be shaped in multiple lengths, without changing the design of the rest of the wind turbine blade profile.

In other words it is an object of this invention to provide a mould for a wind turbine blade and a wind turbine blade having the same overall cross-sectional shape, but with a multitude of possible lengths of the trailing edge and as a consequence thereof also a multitude of possible chord lengths and a multitude of possible degrees of twist.

An object of this invention is also to provide a manufacturing process for a wind turbine blade with such a profile and such a trailing edge.

### DESCRIPTION OF THE INVENTION

As also mentioned above the invention concerns a wind turbine blade mould comprising a first mould part having a first mould surface and a second mould part having a second mould surface, a first end and a second end, where said first mould surface is configured for moulding a pressure side shell of a wind turbine blade, where said second mould surface is configured for moulding a suction side shell of a wind turbine blade, where said first end is configured for moulding a first end e.g. a tip end of a wind turbine blade, and where the second end is configured for moulding a second end e.g. a root end of a wind turbine blade, where the first end is located in the opposite end of the second end, and where the wind turbine blade mould and thus also a wind turbine blade moulded in said mould comprise a first end, a second end, a pressure side shell, a suction side shell, and further comprise a leading edge area and a trailing edge area.

The new and inventive feature of the solution according to the invention is that at least one of the first and second mould parts comprises at least one set of mould inlay, where said mould inlay is arranged at the mould surface and along at least a part of the trailing edge area.

The inlay will along a line constitute the trailing edge in the mould and allow a mould to be used for blades having different chord lengths, i.e. allowing the mould to act as a “multi-mould” or “standard mould”. This is obtained by either manufacturing a solid trailing edge part where the length in the chord direction is adjusted according to specific needs by using one or more selected inlays in the mould. Such inlay or inlays will fill up the area in the mould where the trailing edge could have been extended.

Using this principle it is possible to only adjust the trailing edge on one of the wind turbine blade shell parts as the trailing edge extends from a glue line along the wind turbine blade from at least one of two wind turbine blade shell parts. Such a trailing edge will be solid and may be shaped from only one of the suction or pressure side shell parts.

Another way of obtaining a wind turbine blade having an different chord length in a multi-mould is to have an inlay or more inlays in one or two of the mould parts, where the trailing edge of each of the shell parts is shaped according to an inlay, and where the two wind turbine shell parts are glued together along a common leading edge glue line and also along a common trailing edge glue line.

The chord length of a wind turbine blade moulded in such a mould may be adjusted between 0 to 20%, between 0 to 15% or between 0 to 10% or less or even more.

Wind turbine blades having the same length and rather small differences, e.g. less than 0 to 20%, in the width/chord length, have more or less the same loads, and there is thus no need for separate calculations and documentation for such minor changes.

This means that changing the chord length will not have significant impact on the loads (fatigue loads, extreme loads) seen by a wind turbine blade, or by the wind turbine itself. Changing or adjusting the chord length may however provide a noticeable difference in the energy produced during specific wind conditions such as wind speeds or other conditions that depend on a specific position in relation to one or several other wind turbines located nearby.

Manufacturing of wind turbine blades according to the invention thus allows for production of several types of blades having different trailing edge design, and thus also a different and customised efficiency in a “standard mould”. A wind turbine park can thus be designed to optimise the overall production simply by using wind turbine blades having different designs, but which are produced in the same mould using suitable inlays in the mould. The design of the trailing edge and thus the length of the chord are customised and the annual energy production is optimised.

The mould may comprise one or more inlays at the trailing edge area in one or both mould parts to make the chord and trailing edge longer or shorter according to specific needs.

The mould may also allow the trailing edge to be manufactured in a full length in the chord direction and shaped at a later stage according to specific needs.

In an embodiment of a wind turbine blade mould according to the invention the first mould part for moulding the pressure side shell part may comprise at least one mould inlay at the trailing edge area.

In another embodiment of a wind turbine blade mould according to the invention the second mould part for moulding the suction side shell part may comprise at least one mould inlay at the trailing edge area.

In yet another embodiment of a wind turbine blade mould according to the invention the first mould part for moulding the pressure side shell part may comprise at least one mould inlay at the trailing edge area, and the second mould part for moulding the suction side shell part may comprise at least one mould inlay at the trailing edge area.

The length of the trailing edge in the chord direction is determined by said at least one mould inlay, and the extension in the length direction of the wind turbine blade of the shaped trailing edge is also determined by said one or more mould inlays. It is however the same mould that is used for any of the combinations, and it is thus possible to manufacture different wind turbine blades for specific purposes in a single mould having a standard design that can be adjusted.

Even further the invention also comprises a manufacturing method for producing a wind turbine blade as described below, using a wind turbine mould as described above, where the method comprises the steps of:
arranging a first mould part having a first mould surface comprising a leading edge area and a trailing edge area;
arranging a first layup of one or more layers of fibrous material, e.g. mats and/or rovings from glass, carbon or other types of fibres, directly or indirectly at the first mould surface, where the one or more layers of fibrous material are impregnated with a resin to form a fibre reinforced plastic laminate defining a first wind turbine shell part;
arranging a second mould part having a second mould surface comprising a leading edge area and a trailing edge area;
arranging a second layup of one or more layers of fibrous material, e.g. mats and/or rovings from glass, carbon or other types of fibres, directly or indirectly at the second mould surface, where the one or more layers of fibrous material are impregnated with a resin to form a fibre reinforced plastic laminate defining a second wind turbine blade shell part;
joining said first and second wind turbine blade shells,

The invention differs from the known methods in that before impregnating said layup of fibrous material, preferably before laying up said fibrous material on at least one of the first and second mould surfaces, the following additional step may be performed:
arranging one or more mould inlays along the trailing edge area of at least one of the first and second mould part and thus determining the shape of the trailing edge.

Such an inlay and the shape of it will thus alter/limit the mould surface and of course also the shape of the product produced in that mould using that inlay. An inlay may be a single piece inlay, but may also constitute several inlay parts that are arranged end to end and/or side by side in relation to each other. A solution where a set of inlays are used for a specific blade shape will be the most used solution, but said set of inlays can also be used as a basis for further inlays in order to produce yet a variant of a blade in the same mould.

A manufacturing method according to the invention may also comprise at least an additional step of arranging one or more mould inlays in both the first and second mould parts. This way it is possible to mould blade shell parts for both the pressure side and the suction side with customised trailing edge size/design.

In yet a manufacturing method according to the invention the layup may comprise that fibrous material is impregnated with resin by using RTM (Resin Transfer Moulding), and preferably by using VARTM (Vacuum Assisted Resin Transfer Moulding), where said impregnation is carried out using one of the following methods:
impregnating the first and second wind turbine blade shell in individual operations;
impregnating the first and second wind turbine blade in one single operation.

In a manufacturing method according to the invention the layup may comprise fibrous material that is impregnated with resin prior to laying up the fibrous material by using so-called prepreg materials. Such prepreg materials are known to the skilled person and comprise fibrous material pre-impregnated with resin. The invention can actually be used for all known moulding techniques, where the fibres in one or another way are arranged at a mould surface as known in the wind industry and in related industries.

Using a manufacturing process according to the invention and as described do not limit the manufacturing processes already known, but merely gives an opportunity to design the trailing edge and actually also the leading edge area according to specific needs without having to build a completely new mould. A “standard mould” can be used for multiple different blade designs simply by adding inlays into said “standard mould”. As described above such inlays may advantageously be arranged at the trailing edge, but it is also possible to arrange inlays in other areas of the mould in order to manufacture a specific blade shape for a specific use.

The invention further comprises a wind turbine blade manufactured in a wind turbine blade mould as mentioned above, where the wind turbine blade comprises a pressure side shell part and a suction side shell part, where at least one of the wind turbine shell parts comprises a trailing edge, where the overall shape of the trailing edge is moulded using one or more mould inlays.

Such inlays may as an example be rather simple parts/items that are placed in the trailing edge area in a mould and which simply fill out a selected space and thus moves/alters the shape of the product moulded in the mould. The drawings discussed below will show examples of such inlays.

In an embodiment of a wind turbine blade according to the invention the wind turbine blade at at least one of the pressure side and suction side comprises an extended shell section, where said extended shell section comprises the trailing edge of the wind turbine blade and extends from a longitudinal glue line between the pressure side shell and a suction side shell of a wind turbine blade. In such a solution there is only made changes on either the pressure side or the suction side.

In another embodiment of a wind turbine blade according to the invention the profile of the trailing edge is configured for noise reduction, and e.g. comprises a noise reducing profile arranged at the outermost trailing edge. Such a noise reducing profile may be shaped with a serrated edge, a wave-shaped edge or any other suitable shape of edge, and the trailing edge may be manufactured from any suitable material in order to give the preferred characteristics. In principle the mentioned noise reducing profile may be incorporated into the trailing edge of the wind turbine blade as an insert arranged together with the one or more inlays in the mould at the trailing edge area.

The invention further comprises a wind turbine park comprising a plurality of wind turbines, each of said wind turbines comprises at least two wind turbine blades as described above, wherein said at least two wind turbine blades of the wind turbines have the same longitudinal length and different chord lengths.

Wind turbine blades designed for wind turbines in a wind turbine park can thus be manufactured by using a “standard mould” along with one or more sets of mould inlays. No need for disassembling and reassembling the mould when adjusting the design of the wind turbine blade. Also, no need for multiple moulds each specifically designed with a fixed longitudinal length and a fixed chord length.

The design of the trailing edge area and thus the chord length of the wind turbine blade are adjusted and customised by placing suitable mould inlays in the mould along the trailing edge. The energy production can thus be optimised by manufacturing two or more different types of wind turbine blades for two or more groups of wind turbines in the park.

In an embodiment of a wind turbine park according to the invention, the chord length of the at least two wind turbine blades of a first wind turbine differs from the chord length of the at least two wind turbine blades of a second wind turbine by 0 to 20%.

Each group of wind turbines in the park preferably have wind turbine blades with the same blade length, e.g. of 35 metres or more, but with different chord lengths. A first chord length of a first wind turbine is thus adjusted relative to a second chord length of a second wind turbine. The difference between the first chord length and the second chord length may be between 0 to 20%, between 0 to 15%, or between 0 to 10%, or less or even more.

This difference in the chord lengths will not have significant impact on the loads (fatigue loads and extreme loads) seen by a wind turbine blade, or by the wind turbine itself. The adjustment in the chord length may, however, provide a noticeable difference in the energy produced during specific wind conditions, such as wind speeds or other conditions that depend on a specific position in relation to one or several other wind turbines located nearby. The wind turbine blades will thus be subjected to more or less the same loads, and there is thus no need for separate calculations and documentation for such minor changes.

### DESCRIPTION OF THE DRAWING

The invention is described by example only and with reference to the drawings, wherein:

FIG. 1 shows a wind turbine,

FIG. 2 shows a wind turbine blade with alternative trailing edge design,

FIG. 3 shows a first cross-sectional profile of a wind turbine blade according to the invention,

FIG. 4 shows a second cross-sectional profile of a wind turbine blade according to the invention,

FIG. 5 shows a third cross-sectional profile of a wind turbine blade according to the invention,

FIG. 6 shows a fourth cross-sectional profile of a wind turbine blade according to the invention,

FIG. 7 shows a first cross-sectional view of a mould for a wind turbine blade according to the invention,

FIG. 8 shows a second cross-sectional view of a mould for a wind turbine blade according to the invention.

In the following text, the figures will be described one by one, and the different parts and positions seen in the figures will be numbered with the same numbers in the different figures. Not all parts and positions indicated in a specific figure will necessarily be discussed together with that figure.

### POSITION NUMBER LIST

1. Wind turbine
2. Tower
3. Foundation
4. Nacelle
5. Wind rotor
6. Rotor hub
7. Wind turbine blade
8. First end/tip end
9. Second end/root end
10. Leading edge area
11. Trailing edge area
12. Trailing edge
13. Pressure side
14. Suction side
15. First chord line
16. Second chord line
17. Inlay
18. Leading edge
19. Pressure side mould part
20. Pressure side shell
21. Suction side mould part
22. Suction side shell

### DETAILED DESCRIPTION OF THE INVENTION

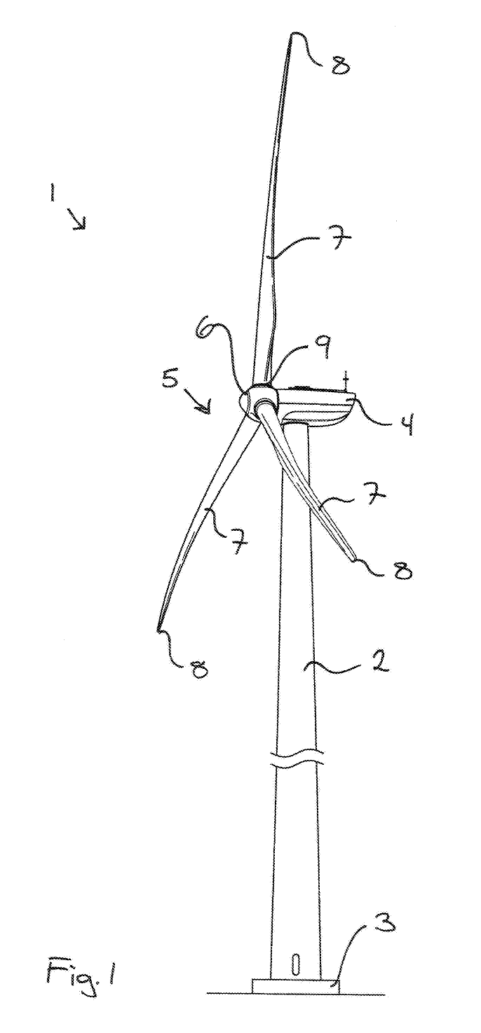

FIG. 1 shows a wind turbine 1 comprising a wind turbine tower 2 installed at a foundation 3. A nacelle 4 is mounted at the top of the wind turbine tower 2, e.g. via a yaw system. The wind turbine tower 2 may comprise one or more tower sections mounted on top of each other. The wind turbine also comprises a wind rotor 5 comprising a rotor hub 6, which is rotatably mounted to the nacelle 4 via a rotor shaft (not seen). On this wind turbine three wind turbine blades 7 are mounted to the rotor hub 6 and extend outwards from the centre of the rotor hub 6 and thus form a rotor plane.

The wind turbine blades 7 comprise a first end/tip end 8 and a second end/root end 9 configured to be mounted to the rotor hub 6. The wind turbine blades 7 comprise an aerodynamic profile along the length of the blade 7, which profile is selected for the specific location, wind conditions and a number of other factors.

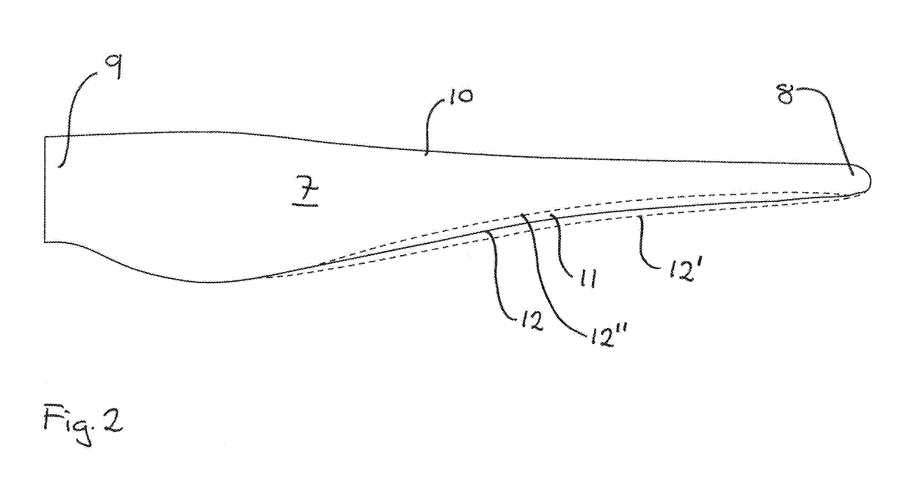

FIG. 2 shows a wind turbine blade 7 having two alternative trailing edge designs. The wind turbine blade extends between a first end 8 and a second end 9 and between a leading edge area 10 and a trailing edge area 11. As can be seen in FIG. 2 the trailing edge area 11 can have different designs, here depicted by two dotted lines 12′, 12″ and a full line 12. The dotted line 12′ indicates a trailing edge moulded without any inlays in the mould, whereas the full line 12 and the dotted line 12″ indicate the result of using two different sets of inlays.

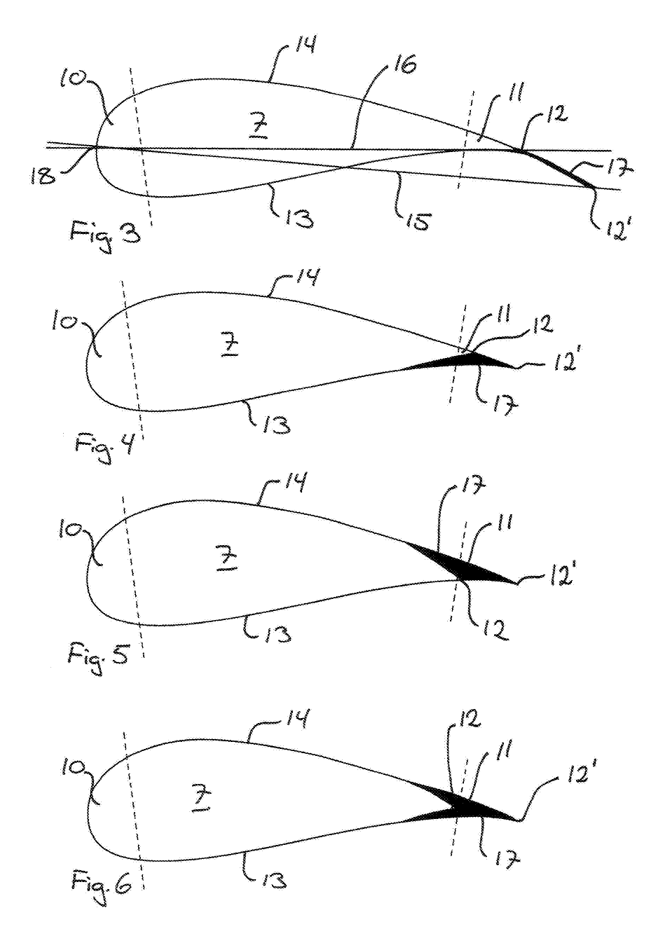

FIG. 3 shows a first cross-sectional profile of a wind turbine blade 7 having a pressure side 13 and a suction side 14. Further a first chord line 15 is seen indicating the chord for a wind turbine blade 7 made with no inlay in the mould and a second chord line 16 indicating the chord for a wind turbine blade 7 manufactured using an inlay 17. Here it is rather clear that using an inlay 17 may change the twist of the blade 7. The difference in the twist is seen as the angular difference between the first chord line 15 and the second chord line 16. FIG. 3 also shows the leading edge area 10 and the trailing edge area 11 indicated with dotted lines in order to illustrate that neither the leading edge area 10 nor the trailing edge area 11 is a very well defined point or line, but merely an area along the leading edge 18 and the trailing edge 12. The inlay 17 is seen as a dark area indicating of course the inlay but also indicating the profile of the wind turbine blade if the inlay 17 was not inserted. It is clear that the inlay is not a part of the blade 7, and it is only seen in FIGS. 3, 4, 5, 6, 7 in order to illustrate how and where an inlay 17 may be used.

FIG. 4 shows a second cross-sectional profile of a wind turbine blade 7, where an inlay 17 is arranged at the pressure side 13 of the blade 7.

FIG. 5 shows a third cross-sectional profile of a wind turbine blade 7, where an inlay 17 is arranged at the suction side 14 of the blade 7.

FIG. 6 shows a fourth cross-sectional profile of a wind turbine blade 7, where an inlay 17 is arranged at both the pressure side 13 and the suction side 14 of the blade 7.

It is to be understood that the inlay or inlays 17 can be fixed to one or both mould parts, and that such a fixation can be performed using fasteners of any suitable kind, and that the inlays 17 might be arranged on hinges or other fixation means that will allow a precise, quick and easy attachment and also detachment.

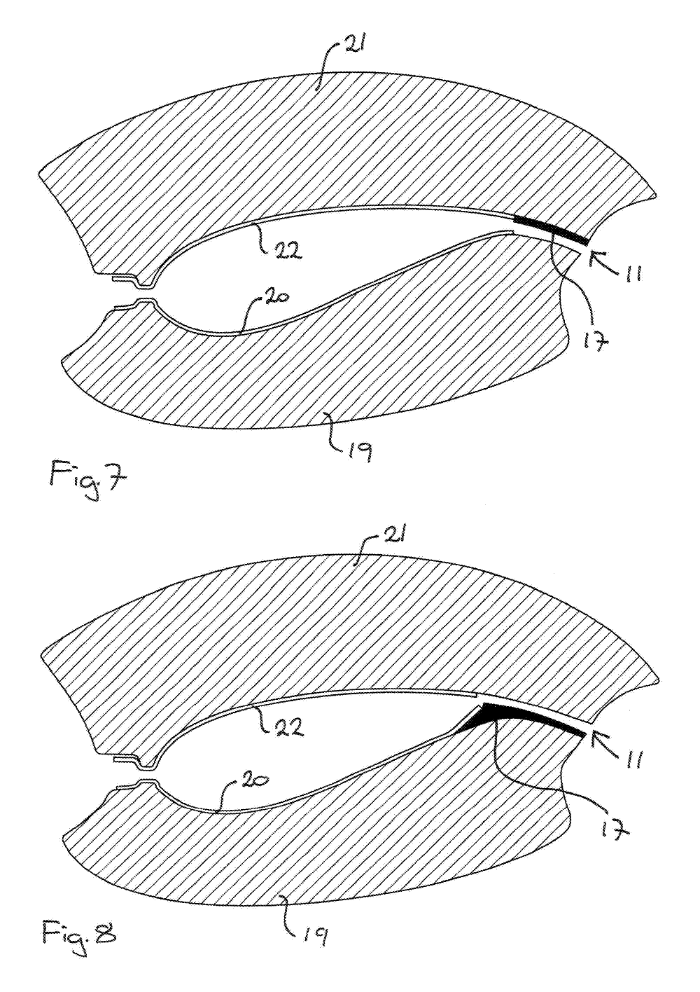

FIG. 7 shows a first cross-sectional view of a mould for a wind turbine blade 7, where the pressure side mould part 19 carry a pressure side shell 20, and where the suction side mould part 21 carries a suction side shell 22. The two shell parts 20, 22 are seen with a small distance in order to illustrate the principle better. In the suction side mould part 21 an inlay 17 is seen at the trailing edge area 11, and this situation is more or less comparable with the cross-section seen in FIG. 3. If the inlay 17 was not installed, the mould parts 19, 21 could be used to produce a wind turbine blade 7 with a longer trailing edge 12′ and thus with a longer chord and another twist.

FIG. 8 shows a second cross-sectional view of a mould for a wind turbine blade 7, where the pressure side mould part 19 carries a pressure side shell 20, and where the suction side mould part 21 carries a suction side shell 22. The two shell parts 20, 22 are seen with a small distance in order to illustrate the principle better. In the pressure side mould part 19 an inlay 17 is seen at the trailing edge area 11, and this situation is more or less comparable with the cross-section seen in FIG. 4. If the inlay 17 was not installed, the mould parts 19, 21 could be used to produce a wind turbine blade with a longer trailing edge 12′ and thus with a longer chord and another twist.

1. A wind turbine blade mould comprising a first mould part having a first mould surface, a second mould part having a second mould surface, a first end and a second end, where said first mould surface is configured for moulding a pressure side shell part of a wind turbine blade, where said second mould surface is configured for moulding a suction side shell part of said wind turbine blade, where said first end is configured for moulding a first end, e.g. a tip end, of said wind turbine blade, and where the second end is configured for moulding a second end, e.g. a root end, of said wind turbine blade, where the first end is located in the opposite end of the second end, and where the wind turbine blade mould and thus also the wind turbine blade moulded in said wind turbine blade mould comprise a first end, a second end, a pressure side, a suction side, and further comprise a leading edge area and a trailing edge area, wherein at least one of the first and second mould parts comprises at least one set of mould inlays, where said mould inlays are arranged at at least one of the first and second mould surfaces, wherein said mould inlays are positioned between the first end and the second end and at the trailing edge area, where the mould inlays extend along at least a part of the trailing edge area, and wherein the at least one set of mould inlays determine different chord lengths while maintaining the longitudinal length of the wind turbine blade.

2. A wind turbine blade mould according to claim 1, wherein the first mould part for moulding the pressure side shell part comprises at least one mould inlay at the trailing edge area.

3. A wind turbine blade mould according to claim 1, wherein the second mould part for moulding the suction side shell part comprises at least one mould inlay at the trailing edge area.

4. A wind turbine blade mould according to claim 1, wherein the first mould part for moulding the pressure side shell part comprises at least one mould inlay at the trailing edge area, and that the second mould part for moulding the suction side shell part comprises at least one mould inlay at the trailing edge area.

5. A manufacturing method for producing a wind turbine blade using a wind turbine blade mould according to claim 1, where the method comprises the steps of:
arranging a first mould part having a first mould surface comprising a leading edge area and a trailing edge area;
arranging a first layup of one or more layers of fibrous material, e.g. mats and/or rovings from glass, carbon or other types of fibres, directly or indirectly at the first mould surface, where the one or more layers of fibrous material are impregnated with a resin to form a fibre reinforced plastic laminate defining a first wind turbine shell part;
arranging a second mould part having a second mould surface comprising a leading edge area and a trailing edge area;
arranging a second layup of one or more layers of fibrous material, e.g. mats and/or rovings from glass, carbon or other types of fibres, directly or indirectly at the second mould surface, where the one or more layers of fibrous material are impregnated with a resin to form a fibre reinforced plastic laminate defining a second wind turbine blade shell part;
joining said first and second wind turbine blade shell parts,
wherein before impregnating said layup of fibrous material, preferably before laying up said fibrous material, on at least one of the first and second mould surfaces, the following additional step is performed:
arranging one or more mould inlays along the trailing edge area of at least one of the first and second mould part, wherein said one or more mould inlays determine the shape of the trailing edge and the chord length of the wind turbine blade.

6. A manufacturing method according to claim 5, wherein the method comprises at least an additional step of arranging one or more mould inlays in both the first and second mould parts.

7. A manufacturing method according to claim 5, wherein at least one of the first and second layups comprising fibrous material is impregnated with resin by using RTM (Resin Transfer Moulding), and preferably by using VARTM (Vacuum Assisted Resin Transfer Moulding), where said impregnation is carried out using one of the following methods:
impregnating the first and second wind turbine blade shell in individual operations;
impregnating the first and second wind turbine blade in one single operation.

8. A manufacturing method according to claim 5, wherein at least one of the first and second layups comprising fibrous material is impregnated with resin prior to laying up the fibrous material by using prepreg materials.

9. A wind turbine blade manufactured in a wind turbine blade mould according to claim 1, wherein the wind turbine blade comprises a pressure side shell part and a suction side shell part, where at least one of the wind turbine shell parts comprises a trailing edge area, where the overall shape of the trailing edge area is defined by the shape of one or more mould inlays when said at least one wind turbine shell part is placed in the wind turbine blade mould.

10. A wind turbine blade according to claim 9, wherein the wind turbine blade at at least one of the pressure side and suction side comprises an extended shell section, where said extended shell section comprises the trailing edge of the wind turbine blade and extends from a longitudinal glue line between the pressure side shell and a suction side shell of a wind turbine blade.

11. A wind turbine blade according to claims 9, wherein the trailing edge area comprises a noise reducing profile arranged at the outermost trailing edge.

12. A wind turbine park comprising a plurality of wind turbines, each of said wind turbines comprises at least two wind turbine blades according to claim 9, wherein said at least two wind turbine blades of the wind turbines have the same longitudinal length and different chord lengths.

13. A wind turbine park according to claim 12, wherein the chord length of the at least two wind turbine blades of a first wind turbine differs from the chord length of the at least two wind turbine blades of a second wind turbine by 0 to 20%.
